(19) United States
(12) Patent Application Publication
(10) Pub. No.: US 2026/0103140 A1
(43) Pub. Date: Apr. 16, 2026

(54) VEHICLE LAMP CONTROL SYSTEM, CONTROL METHOD FOR VEHICLE LAMP CONTROL SYSTEM, AND PROGRAM

(71) Applicant: TOYOTA JIDOSHA KABUSHIKI KAISHA, Toyota-shi (JP)

(72) Inventor: Motoaki HACHISUKA, Nagoya-shi (JP)

(73) Assignee: TOYOTA JIDOSHA KABUSHIKI KAISHA, Toyota-shi (JP)

(21) Appl. No.: 19/350,433

(22) Filed: Oct. 6, 2025

(30) Foreign Application Priority Data
Oct. 15, 2024 (JP) 2024-179746

(51) Int. Cl. B60Q 1/14

(52) U.S. Cl. CPC B60Q 1/1423; B60Q 2300/40

(57) ABSTRACT

A vehicle lamp control system that, when an irradiation control target in front of a vehicle is detected, performs dimming control to suppress glare of the irradiation control target by controlling light irradiation from lamps of the vehicle, the system comprising a control target area setting unit that sets a dimming target area for the dimming control for the irradiation control target, wherein the control target area setting unit changes the dimming target area according to a moving direction of the irradiation control target or a face orientation of the irradiation control target when the irradiation control target is a person.

### CROSS-REFERENCE TO RELATED APPLICATIONS

This application is based upon and claims the benefit of priority from Japanese Patent Application No. 2024-179746, filed on October 15, 2024, the entire contents of which are incorporated herein by reference.

### TECHNICAL FIELD

The present invention relates to a vehicle lamp control system, a control method for a vehicle lamp control system, and a program.

### BACKGROUND

Conventionally, Japanese Unexamined Patent Application Publication No. 2014-101069 is known as a technical document related to vehicle lamp control systems. This publication discloses a control device that performs dimming control using a light distribution map corresponding to a steering angle, in dimming control for improving nighttime visibility and preventing glare to others. In this control device, by using the light distribution map corresponding to the steering angle, it is possible to suppress glare to a preceding vehicle even when passing through a curved road and to improve forward visibility.

### SUMMARY

However, as in the above-described related art device, in a case where dimming control is performed on a pedestrian in a predetermined region based on a light distribution map corresponding to a steering angle, there has been a problem that the pedestrian sometimes moves out of the region of the dimming control due to the movement of the pedestrian.

An aspect of the present invention is a vehicle lamp control system that performs dimming control to suppress glare of an irradiation control target by controlling light irradiation from lamps of a vehicle when an irradiation control target in front of the vehicle is detected, the system comprising a control target area setting unit that sets a dimming target area for the dimming control for the irradiation control target, wherein the control target area setting unit changes the dimming target area according to a moving direction of the irradiation control target or a face orientation of the irradiation control target when the irradiation control target is a person.

According to the vehicle lamp control system of one aspect of the present invention, since the dimming target area is changed according to the moving direction of the irradiation control target or the face orientation of the irradiation control target, the dimming target area can be set more appropriately as compared to a case where the moving direction or orientation of the irradiation control target is not considered.

In the vehicle lamp control system according to one aspect of the present invention, the irradiation control target is a pedestrian or a bicycle, and the control target area setting unit may set the dimming target area so as to include a head of the irradiation control target or a head of a person riding the bicycle. According to this vehicle lamp control system, the occurrence of glare can be suppressed by setting the dimming target area so as to include the head of the irradiation control target or the head of the person riding the bicycle.

In the vehicle lamp control system according to one aspect of the present invention, the control target area setting unit may set the dimming target area such that a lateral width of the dimming target area is larger when the irradiation control target is moving in a lateral direction as viewed from the vehicle, as compared to when the irradiation control target is not moving in the lateral direction. According to this vehicle lamp control system, by setting the lateral width of the dimming target area to be larger when the irradiation control target is moving in the lateral direction as viewed from the vehicle, as compared to when the irradiation control target is not moving in the lateral direction, it is possible to make it less likely for the irradiation control target to move out of the dimming target area even if the irradiation control target moves in the lateral direction, and it is possible to appropriately set the dimming target area based on the situation of the irradiation control target.

In the vehicle lamp control system according to one aspect of the present invention, the control target area setting unit may set the dimming target area such that a lateral width of the dimming target area is larger when a face of the irradiation control target is facing in a lateral direction as viewed from the vehicle, as compared to when the face of the irradiation control target is not facing in the lateral direction. According to this vehicle lamp control system, by setting the lateral width of the dimming target area to be larger when the irradiation control target is facing in the lateral direction, as compared to when the irradiation control target is not facing in the lateral direction, it is possible to make it less likely for the irradiation control target to move out of the dimming target area even if the irradiation control target starts moving in the lateral direction after changing the face orientation, and it is possible to appropriately set the dimming target area based on the situation of the irradiation control target.

Another aspect of the present invention is a control method for a vehicle lamp control system that, when an irradiation control target in front of a vehicle is detected, performs dimming control to suppress glare of the irradiation control target by controlling light irradiation from lamps of the vehicle, the method setting a dimming target area for the dimming control for the irradiation control target, and changing the dimming target area according to a moving direction of the irradiation control target or a face orientation of the irradiation control target when the irradiation control target is a person.

According to the control method for a vehicle lamp control system of another aspect of the present invention, since the dimming target area is changed according to the moving direction of the irradiation control target or the face orientation of the irradiation control target, the dimming target area can be set more appropriately as compared to a case where the moving direction or orientation of the irradiation control target is not considered.

Yet another aspect of the present invention is a non-transitory computer-readable storage media stored a program that causes a computer of a vehicle to operate to perform dimming control to suppress glare of an irradiation control target by controlling light irradiation from lamps of the vehicle when the irradiation control target in front of the vehicle is detected, the program causing the computer of the vehicle to operate as a control target area setting unit that sets a dimming target area for the dimming control for the irradiation control target, and in the control target area setting unit, changing the dimming target area according to a moving direction of the irradiation control target or a face orientation of the irradiation control target when the irradiation control target is a person.

According to the program of yet another aspect of the present invention, since the dimming target area is changed according to the moving direction of the irradiation control target or the face orientation of the irradiation control target, the dimming target area can be set more appropriately as compared to a case where the moving direction or orientation of the irradiation control target is not considered.

According to each aspect of the present invention, the dimming target area can be appropriately set according to the moving direction of the irradiation control target or the face orientation of the irradiation control target.

### BRIEF DESCRIPTION OF THE DRAWINGS

FIG. 1 is a block diagram illustrating a vehicle lamp control system according to an embodiment.

FIG. 2 is a diagram illustrating an example of a situation where a pedestrian, who is an irradiation control target, is standing still.

FIG. 3 is a diagram illustrating an example of a situation where a pedestrian, who is an irradiation control target, is moving laterally toward a road.

FIG. 4 is a diagram illustrating an example of a situation where a pedestrian, who is an irradiation control target, is about to cross a road.

FIG. 5 is a flowchart illustrating an example of a dimming control process.

FIG. 6 is a flowchart illustrating an example of a dimming target area setting process.

### DETAILED DESCRIPTION

Hereinafter, embodiments of the present invention will be described with reference to the drawings.

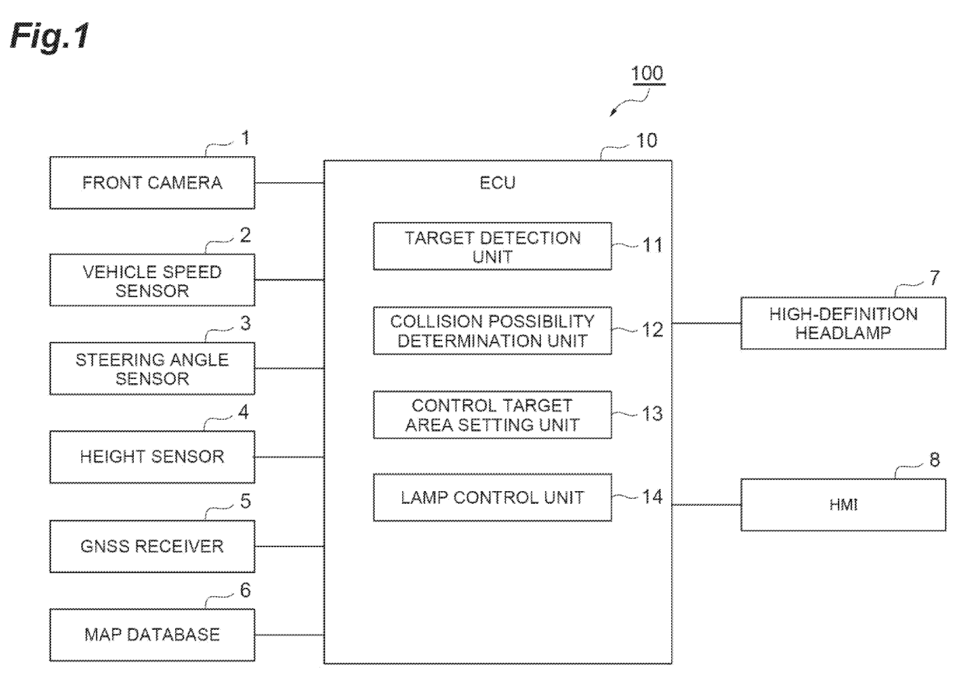

FIG. 1 is a block diagram illustrating a vehicle lamp control system 100 according to one embodiment. The vehicle lamp control system 100 shown in FIG. 1 is a system that is mounted on a vehicle such as a passenger car or a freight vehicle and controls the irradiation of light by a high-definition headlamp 7 of the vehicle. The vehicle may be a vehicle having an autonomous driving function.

The vehicle lamp control system 100 is provided with a function to detect an irradiation control target such as a pedestrian or a bicycle at night or in a space with low illuminance, and to perform dimming control to reduce glare to these targets. The vehicle lamp control system 100 also has a function of determining whether to perform dimming control based on the possibility of collision between the vehicle and the irradiation control target.

The dimming control for the irradiation control target may be a part of the function of ADB [Adaptive Driving Beam], or may be a function separate from ADB. The dimming control is executed when the high-definition headlamp 7 of the vehicle is turned on. The dimming control may be an aspect in which it is executed only when the high-definition headlamp 7 is on high beam, or it may be an aspect in which it is executed regardless of high beam or low beam. A known condition can be adopted as a start condition for the dimming control.

### Configuration of Vehicle Lamp Control System

As shown in FIG. 1, the vehicle lamp control system 100 includes an ECU (Electronic Control Unit) 10 that centrally manages this system. The ECU 10 is an electronic control unit having a CPU (Central Processing Unit) and a storage unit. The storage unit is configured from, for example, a ROM (Read Only Memory), a RAM (Random Access Memory), an EEPROM (Electrically Erasable Programmable Read-Only Memory), and the like. In the ECU 10, for example, various functions are realized by the CPU executing a program stored in the storage unit. The ECU 10 may be configured from a plurality of electronic units.

The ECU 10 is connected to a front camera 1, a vehicle speed sensor 2, a steering angle sensor 3, a height sensor 4, a GNSS receiver 5, a map database 6, a high-definition headlamp 7, and an HMI 8.

The front camera 1 is a camera that captures an image of the front of the vehicle. The front camera 1 captures an image of an irradiation area (irradiation direction) of the high-definition headlamp 7. The front camera 1 transmits the captured image to the ECU 10. The vehicle speed sensor 2 detects a speed of the vehicle and transmits the information to the ECU 10. The steering angle sensor 3 detects a steering angle of the vehicle and transmits the information to the ECU 10.

The height sensor 4 is a sensor for detecting a vehicle height. The height sensor 4 detects that the vehicle height fluctuates according to a front-rear inclination or a change in load of the vehicle. Specifically, the height sensor 4 is attached to a suspension system of the vehicle, and detects a change in the vehicle height when the vehicle height fluctuates due to loading of luggage or getting on and off of an occupant. The height sensor 4 transmits information on the vehicle height to the ECU 10.

The GNSS receiver 5 receives signals from a Global Navigation Satellite System (GNSS) and specifies a position of the vehicle. The GNSS receiver 5 may be a part of GPS (Global Positioning System). The GNSS receiver 5 transmits the measured vehicle position information to the ECU 10.

The map database 6 is a database that stores map information. The map database 6 is stored, for example, in a storage device such as an HDD (Hard Disk Drive) mounted on the vehicle. The map information includes road position information, road shape information (for example, types of curves and straight sections, curvature of curves, etc.), and position information of intersections and branch points and the like. The map information may also include traffic regulation information such as a speed limit associated with the position information. The map database 6 may be formed on an external server capable of communicating with the vehicle.

The high-definition headlamp 7 is a headlamp of the vehicle. The high-definition headlamp 7 is composed of, for example, micro LEDs or matrix LEDs, and is configured to be able to adjust the amount of light irradiated in a specific direction (specific area) in response to an instruction from the ECU 10. The high-definition headlamp 7 is capable of individually controlling a large number of minute light sources, and has, for example, a resolution of about 20,000. The vehicle lamps controlled by the vehicle lamp control system 100 are not limited to the high-definition headlamp 7. The vehicle lamp may be any lamp that can adjust the amount of light irradiated in a specific direction (specific area) in response to an instruction from the ECU 10.

The HMI 8 is an interface for inputting and outputting information between the ECU 10 and a driver. The HMI 8 includes, for example, a display, a speaker, and the like provided in a vehicle cabin. The HMI 8 performs image output of the display and audio output from the speaker in response to a control signal from the ECU 10. The display may be an MID (Multi Information Display) or an HUD (Head Up Display). The HMI 8 may be provided with various indicators. The ECU 10 does not necessarily need to be connected to the height sensor 4, the GNSS receiver 5, the map database 6, and the HMI 8.

Next, a functional configuration of the ECU 10 will be described. As shown in FIG. 1, the ECU 10 includes a target detection unit 11, a collision possibility determination unit 12, a control target area setting unit 13, and a lamp control unit 14. A part of the processing of these ECUs 10 may be executed by an external server.

The target detection unit 11 detects an irradiation control target located in front of the vehicle based on image data acquired from the front camera 1. The target detection unit 11 may perform detection of the irradiation control target by a machine learning algorithm or a deep learning-based algorithm, or may perform detection of the irradiation control target by a rule-based algorithm.

Specifically, the target detection unit 11 receives image data transmitted from the front camera 1, and detects an irradiation control target using image recognition technology. The target detection unit 11 first performs image preprocessing such as noise removal and contrast adjustment on the image data. This improves the quality of the image data and increases the recognition accuracy of the irradiation control target.

Next, the target detection unit 11 extracts features from the preprocessed image data. As the features, HOG (Histogram of Oriented Gradients), SIFT (Scale-Invariant Feature Transform), or the like is used. These features are used to represent a shape or a texture of the irradiation control target. After the features are extracted, the target detection unit 11 detects the irradiation control target using a machine learning or deep learning technique. For example, the irradiation control target is detected from the features using a machine learning algorithm such as a support vector machine (SVM) or a random forest. In addition, as deep learning-based algorithms, CNN (Convolutional Neural Network), YOLO (You Only Look Once), SSD (Single Shot MultiBox Detector), or the like may be used.

The target detection unit 11 sets a target area based on the position information of the detected irradiation control target, and tracks the irradiation control target between consecutive image frames. For tracking the irradiation control target, a color-based tracking method or a method using optical flow is employed. Thereby, even when the irradiation control target is moving, its position can be accurately grasped. In addition, a moving direction of the irradiation control target can be detected.

The target detection unit 11 determines whether the detected irradiation control target is a pedestrian or a bicycle. Various algorithms and pattern matching techniques are used for this. For example, the type of the irradiation control target is determined based on the characteristic shape and movement of a pedestrian or the shape and movement of a bicycle.

Furthermore, the target detection unit 11 may detect the head of the pedestrian and recognize the pedestrian's face orientation. This makes it possible to determine whether the pedestrian is facing the travel direction of the vehicle or facing another direction. The pedestrian's face orientation is important information for predicting the pedestrian's intention or behavior.

The target detection unit 11 may determine the moving direction of the pedestrian. The target detection unit 11 determines that the irradiation control target is moving in a lateral direction, for example, when a longitudinal speed of the pedestrian is less than a certain value and a lateral speed of the pedestrian is equal to or greater than the certain value. The longitudinal direction is the front-rear direction of the vehicle, that is, the forward direction of the vehicle or the rearward direction of the vehicle.

Similarly, the target detection unit 11 may determine that the irradiation control target is moving in a longitudinal direction when the longitudinal speed of the irradiation control target is equal to or greater than a certain value and the lateral speed of the irradiation control target is less than a certain value. The target detection unit 11 may perform prediction of the pedestrian's course from a detection result of the pedestrian. The target detection unit 11 predicts, for example, a course on which the pedestrian is about to cross a road. The above-described face orientation, moving direction, and course prediction can be similarly performed when the irradiation control target is a bicycle.

The collision possibility determination unit 12 determines a possibility of collision between the vehicle and the irradiation control target. Specifically, the collision possibility determination unit 12 predicts a course of the vehicle based on information from the vehicle speed sensor 2, the steering angle sensor 3, the GNSS receiver 5, and the map database 6. The collision possibility determination unit 12 calculates the possibility of collision between the vehicle and the irradiation control target from the predicted course of the vehicle and the course of the irradiation control target predicted by the target detection unit 11.

The collision possibility determination unit 12 determines, for example, whether the course of the vehicle and the course of the irradiation control target intersect, or whether the irradiation control target is moving toward the course of the vehicle. The collision possibility determination unit 12 determines that the possibility of collision is higher when the irradiation control target is moving toward the course of the vehicle than when the irradiation control target is not moving toward the course of the vehicle. On the other hand, when the irradiation control target is moving away from the course of the vehicle, it is determined that the possibility of collision is low.

The collision possibility determination unit 12 may determine the collision possibility in three levels: high, medium, and low. The collision possibility determination unit 12 determines that the collision possibility is high when the collision possibility is equal to or greater than a first threshold value. The collision possibility determination unit 12 determines that the collision possibility is medium when the collision possibility is less than the first threshold value and equal to or greater than a second threshold value. The second threshold value is smaller than the first threshold value. The collision possibility determination unit 12 determines that the collision possibility is low when the collision possibility is less than the second threshold value.

The collision possibility determination unit 12 may perform calculation of the collision possibility or determination of the collision possibility using a machine learning algorithm or a deep learning algorithm. The collision possibility determination unit 12 may determine the collision possibility using a machine learning algorithm or a deep learning algorithm, for example, with the course of the vehicle and the course of the irradiation control target as input. The collision possibility determination unit 12 may determine the collision possibility using a machine learning algorithm or a deep learning algorithm with the vehicle speed and steering angle and the detection result of the irradiation control target as input, without performing course prediction. The calculation method and determination method of the collision possibility are not limited to the contents described above, and a well-known method can be adopted. The collision possibility determination unit 12 may determine the collision possibility in two levels of high and low, or may determine it in four or more levels.

The control target area setting unit 13 sets a dimming target area for the dimming control for the irradiation control target when it is not determined that the collision possibility is high (for example, when it is determined that the collision possibility is medium or low). Specifically, the control target area setting unit 13 sets a dimming target area including a head of the irradiation control target based on position information of the irradiation control target provided from the target detection unit 11. The dimming target area is an area where a light amount of the high-definition headlamp 7 is reduced in order to suppress glare to the irradiation control target. The dimming target area may include the head of the irradiation control target, which is a pedestrian or a bicycle, and may include an upper body or a whole body of the irradiation control target.

The control target area setting unit 13 changes the dimming target area according to the moving direction of the irradiation control target or the face orientation of the irradiation control target. The change of the dimming target area includes a change of a size of the dimming target area or a change of a shape of the dimming target area. The control target area setting unit 13 sets the dimming target area such that a lateral width of the dimming target area is larger, for example, when the irradiation control target is moving in a lateral direction as viewed from the vehicle, as compared to when the irradiation control target is not moving in the lateral direction.

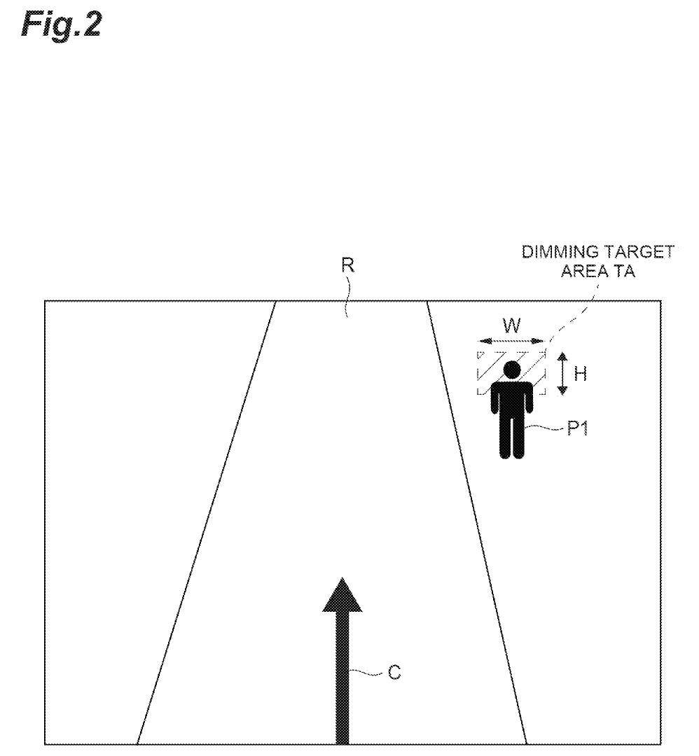

Here, FIG. 2 is a diagram illustrating an example of a situation where a pedestrian, who is an irradiation control target, is standing still. FIG. 2 illustrates a road R on which the vehicle travels, a course C of the vehicle, a pedestrian P1 who is standing still, and a dimming target area TA. In addition, a lateral width W and a height H of the rectangular dimming target area TA are illustrated. As shown in FIG. 2, the control target area setting unit 13 sets a dimming target area TA including the face and upper body of the pedestrian P1, for example, in the case of a standing pedestrian P1.

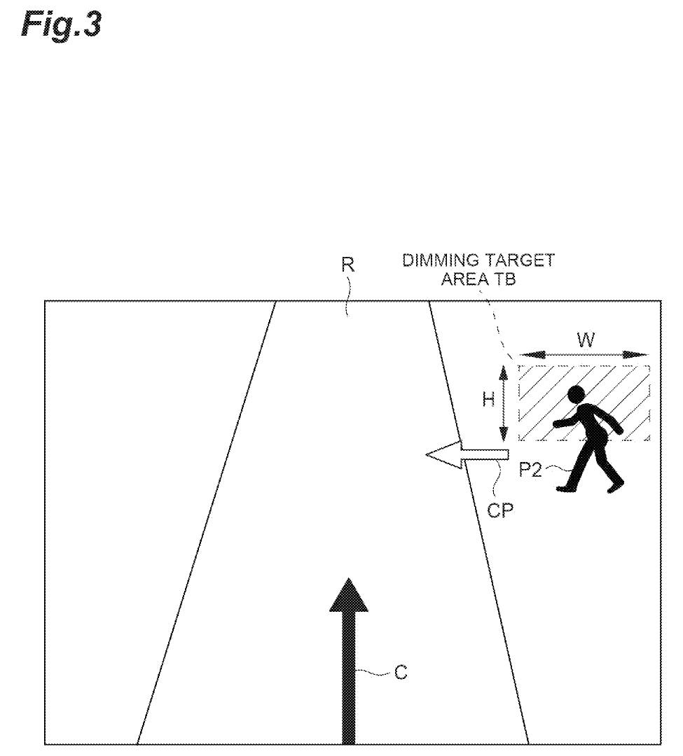

FIG. 3 is a diagram illustrating an example of a situation where a pedestrian, who is an irradiation control target, is moving laterally toward a road. The lateral direction is a sideways direction when viewed from the vehicle. The lateral direction corresponds to a vehicle width direction of the vehicle. FIG. 3 illustrates a pedestrian P2 moving in the lateral direction, a course CP of the pedestrian P2, and a dimming target area TB. As shown in FIG. 3, the control target area setting unit 13 sets a dimming target area TB of a larger size for the pedestrian P2 moving in the lateral direction, as compared to the pedestrian P1 of FIG. 2. The dimming target area TB is an area including the face and upper body of the pedestrian P2. It is assumed that it was not determined that the pedestrian P2 shown in FIG. 3 has a high possibility of collision with the vehicle.

The control target area setting unit 13 sets the width W of the dimming target area TB of the pedestrian P2 moving in the lateral direction to be larger than the dimming target area TA of the standing pedestrian P1. The control target area setting unit 13 may make the height H of the dimming target area TA and the dimming target area TB the same. In other words, the control target area setting unit 13 may make the dimming target area TB a horizontally long rectangular shape as compared to the dimming target area TA. This can reduce the possibility that the face of the pedestrian P2 moving in the lateral direction will be out of the dimming target area TB and cause glare. In this case, the lateral direction may be a direction away from the traveling road R of the vehicle.

The control target area setting unit 13 may set the dimming target area TB such that both the width W and the height H are larger than the dimming target area TA of FIG. 2 when the pedestrian P2 is moving in an oblique direction, not directly sideways. The control target area setting unit 13 may tilt the dimming target area TB so that the moving direction of the pedestrian P2 matches the width direction of the dimming target area TB. The control target area setting unit 13 may change the dimming target area TB so that the area extends in the moving direction of the pedestrian P2.

The control target area setting unit 13 may change the size or shape of the dimming target area of a pedestrian moving in a longitudinal direction as compared to the dimming target area TA of the standing pedestrian P1. For example, the control target area setting unit 13 may set the height H of the dimming target area of the pedestrian moving in the longitudinal direction to be larger than the dimming target area TA of the standing pedestrian P1. The control target area setting unit 13 may make the width W of the dimming target area of a pedestrian moving in the longitudinal direction larger than the dimming target area TA, or may not change it. The width W of the dimming target area of a pedestrian moving in the longitudinal direction may be made smaller. This can reduce the possibility that the face of a pedestrian moving in the longitudinal direction will be out of the dimming target area and cause glare.

The control target area setting unit 13 may set the dimming target area such that the lateral width is larger when the irradiation control target is facing in the lateral direction as compared to when the irradiation control target is not facing in the lateral direction, even when the irradiation control target is not moving in the lateral direction. Specifically, the control target area setting unit 13 may set the width W of the dimming target area TA to be larger when the face of the pedestrian P1 is facing in the lateral direction in the standing pedestrian P1 shown in FIG. 2, as compared to when the face of the pedestrian P1 is not facing in the lateral direction.

The control target area setting unit 13 may also apply the change of the width W due to the face orientation even when the pedestrian P1 is moving in the longitudinal direction (for example, moving in a direction facing the vehicle in the front-rear direction of the vehicle). The control target area setting unit 13 may set the width W of the dimming target area TA to be larger when the face of the pedestrian P1 is facing in the lateral direction as compared to when the pedestrian P1 is not facing in the lateral direction, because there is a possibility that the pedestrian P1 will move in the lateral direction, even when the pedestrian P1 is moving in the longitudinal direction.

The control target area setting unit 13 may make the size of the dimming target area larger when the irradiation control target is a bicycle than when the irradiation control target is a pedestrian. This is because the moving speed of a bicycle is faster than that of a pedestrian.

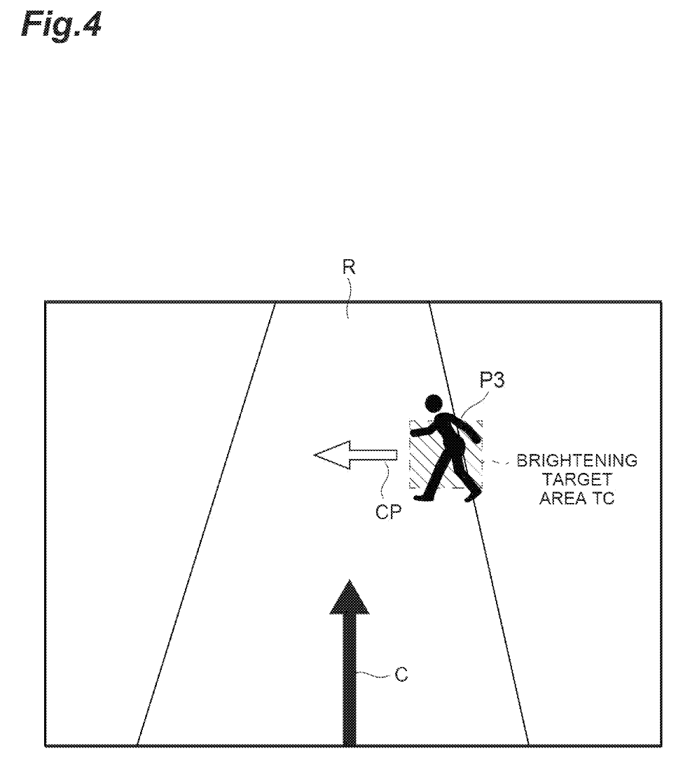

The control target area setting unit 13 may set a brightening target area for the irradiation control target when it is determined that the possibility of collision is high. The control target area setting unit 13 sets the brightening target area for a part of the irradiation control target that does not cause glare to the irradiation control target. Here, FIG. 4 is a diagram illustrating an example of a situation where a pedestrian who is an irradiation control target is about to cross a road. FIG. 4 shows a pedestrian P3 moving in a lateral direction on a traveling road R and a brightening target area TC. Regarding the pedestrian P3 shown in FIG. 4, it is assumed that the collision possibility determination unit 12 has determined that the possibility of collision with the vehicle is high.

In this case, the control target area setting unit 13 sets the brightening target area TC for a body part of the pedestrian P3 so as not to include the head of the pedestrian P3. The control target area setting unit 13 sets the brightening target area TC that does not include the head in order to avoid increasing the probability of glare of the pedestrian P3 due to brightening. The brightening target area TC may be an area including from a lower half of the body to the feet of the pedestrian P3, or may be an area including the entire body from the neck down. If the irradiation control target is a bicycle, the brightening target area TC may not include the head of a person riding the bicycle. The brightening target area TC may be an area including only a bicycle portion not including the person riding the bicycle, or may be an area including a leg portion of the person riding the bicycle, and the like. The control target area setting unit 13 may be configured to set the dimming target area based on a determination of whether to perform dimming control in the lamp control unit 14, which will be described later. The same applies to the brightening target area.

The lamp control unit 14 controls the high-definition headlamp 7 of the vehicle. The lamp control unit 14 determines whether to perform dimming control for the irradiation control target based on the possibility of collision between the vehicle and the irradiation control target determined by the collision possibility determination unit 12.

When it is determined that the possibility of collision between the vehicle and the irradiation control target is high, the lamp control unit 14 determines not to perform dimming control for the said irradiation control target. In this case, the lamp control unit 14 may execute brightening control for the said irradiation control target. The brightening control is a control for improving the recognition accuracy of the irradiation control target by the front camera 1 by increasing the amount of light irradiated by the high-definition headlamp 7 to the irradiation control target with a high possibility of collision. The lamp control unit 14, for example, precisely adjusts the light amount for a specific area by individually controlling each light source of the high-definition headlamp 7 composed of micro LEDs or matrix LEDs.

The lamp control unit 14 performs brightening control to increase the amount of light irradiated by the high-definition headlamp 7 to the brightening target area set by the control target area setting unit 13. The increase in the light amount may be a constant value, or may be an aspect in which the light amount is increased until a detection reliability by the front camera 1 becomes a predetermined value or more. The detection reliability by the front camera 1 can be calculated by a well-known method from the features of the image using a machine learning algorithm such as a support vector machine or a random forest, or a deep learning-based algorithm. The vehicle lamp control system 100 may notify the driver of the vehicle via the HMI 8 that the amount of light irradiated to the attention target will be increased when performing the brightening control. The vehicle lamp control system 100 may perform the notification by displaying an image or text on the display of the HMI 8, or may perform the notification by audio output from a speaker.

With the brightening control, the lamp control unit 14 enables the front camera 1 to detect the irradiation control target more accurately, and can appropriately execute vehicle support from a driving support system (for example, PCS (Pre-Crash Safety)). The PCS is a system that provides a function of automatically applying brakes when the risk of collision is high, and its effect can be enhanced by improving the recognition accuracy of the irradiation control target.

When it is not determined that the possibility of collision between the vehicle and the irradiation control target is high (for example, when the possibility of collision is medium or low), the lamp control unit 14 executes dimming control for the said irradiation control target. The lamp control unit 14, for example, gradually reduces the light amount of the high-definition headlamp 7 for the dimming target area of the irradiation control target.

The lamp control unit 14 may change a dimming amount in the dimming control based on the possibility of collision between the vehicle and the irradiation control target. The lamp control unit 14 may make the dimming amount of the dimming control for the irradiation control target smaller when the collision possibility is medium than when the collision possibility is low. The lamp control unit 14 can, for example, when it is determined that the closer the pedestrian P2 in FIG. 3 is to the traveling road R, the higher the possibility of collision is, make the dimming amount of the dimming control for the pedestrian P2 smaller as the pedestrian P2 is closer to the traveling road R, thereby avoiding a decrease in the detection accuracy of the front camera 1 due to dimming.

Similarly, the lamp control unit 14 may make the amount of dimming of the dimming control for the irradiation control target smaller as the possibility of collision increases. Also in this case, by appropriately reducing the amount of light to the irradiation control target, it is possible to suppress glare and, depending on the possibility of collision, avoid a decrease in the detection accuracy of the front camera 1 due to dimming.

### Program

The program causes the ECU 10 (computer) to function (operate) as the above-described target detection unit 11, collision possibility determination unit 12, control target area setting unit 13, and lamp control unit 14. The program is provided, for example, by a non-transitory recording medium such as a ROM or a semiconductor memory. The program may also be provided from a network or the like via wireless communication.

### Control Method of Vehicle Lamp Control System

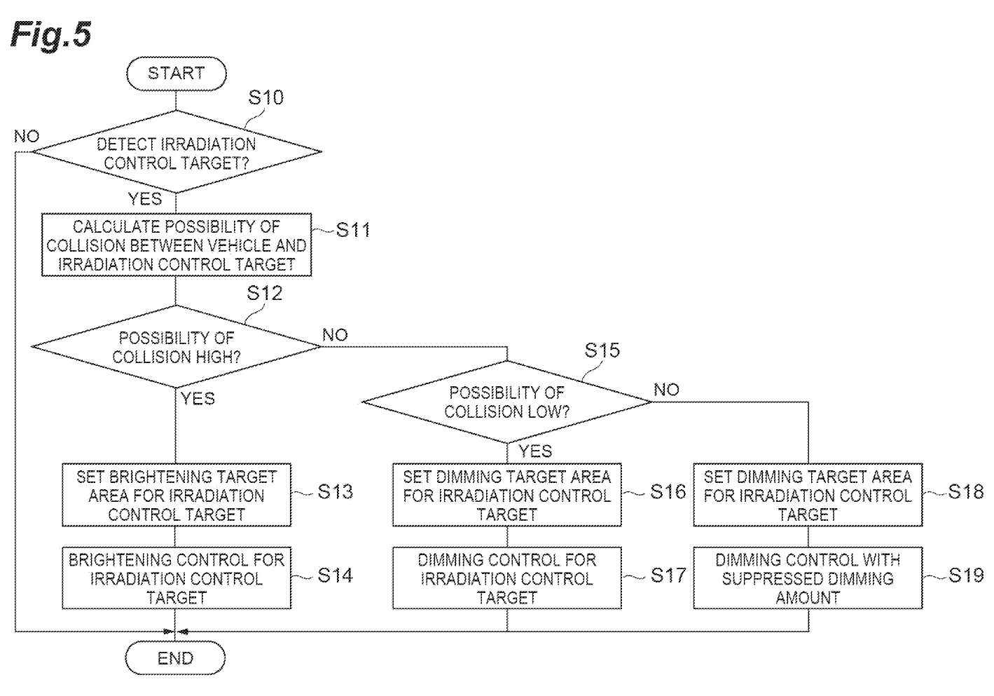

Next, a control method of the vehicle lamp control system 100 according to the present embodiment will be described with reference to the drawings. FIG. 5 is a flowchart illustrating an example of a dimming control process. The dimming control process is executed when the high-definition headlamp 7 is switched to high beam in a case where the user of the vehicle has turned ON the dimming control function.

As shown in FIG. 5, in step S10, the ECU 10 detects an irradiation control target using the target detection unit 11 based on image data acquired from the front camera 1. When no irradiation control target is detected, the ECU 10 ends the dimming control process. On the other hand, when an irradiation control target is detected, the ECU 10 proceeds to step S11.

In step S11, the ECU 10 calculates a possibility of a collision between the vehicle and the irradiation control target using the collision possibility determination unit 12 based on information from the vehicle speed sensor 2, the steering angle sensor 3, the GNSS receiver 5, and the map database 6. Specifically, the possibility of collision is calculated based on whether the course of the vehicle and the course of the irradiation control target intersect, or whether the irradiation control target is moving toward the course of the vehicle.

Next, in step S12, the ECU 10 determines whether the possibility of collision is high. When it is determined that the possibility of collision is high, the ECU 10 proceeds to step S13. In step S13, the ECU 10 uses the control target area setting unit 13 to set a brightening target area for the irradiation control target. Subsequently, in step S14, the ECU 10 uses the lamp control unit 14 to execute brightening control for the irradiation control target by the high-definition headlamp 7. This improves the visibility of the irradiation control target and can reduce the risk of collision. Thereafter, the ECU 10 ends the dimming control process.

On the other hand, when it is determined in step S12 that the possibility of collision is not high, the ECU 10 proceeds to step S15. In step S15, the ECU 10 determines whether the possibility of collision is low. When it is determined that the possibility of collision is low, the ECU 10 proceeds to step S16. In step S16, the ECU 10 uses the control target area setting unit 13 to set a dimming target area for the irradiation control target. Subsequently, in step S17, the ECU 10 uses the lamp control unit 14 to execute dimming control for the irradiation control target by the high-definition headlamp 7. This makes it possible to suppress glare to the irradiation control target. Thereafter, the ECU 10 ends the dimming control process.

When it is determined in step S15 that the possibility of collision is not low, that is, when it is determined that the possibility of collision is medium, the ECU 10 proceeds to step S18. In step S18, the ECU 10 uses the control target area setting unit 13 to set a dimming target area for the irradiation control target. Subsequently, in step S19, the ECU 10 uses the lamp control unit 14 to execute dimming control with a suppressed amount of dimming. This is dimming control with a suppressed amount of dimming as compared to step S17. This makes it possible to avoid a decrease in the detection accuracy of the front camera 1 due to dimming, depending on the possibility of collision. Thereafter, the ECU 10 ends the dimming control process.

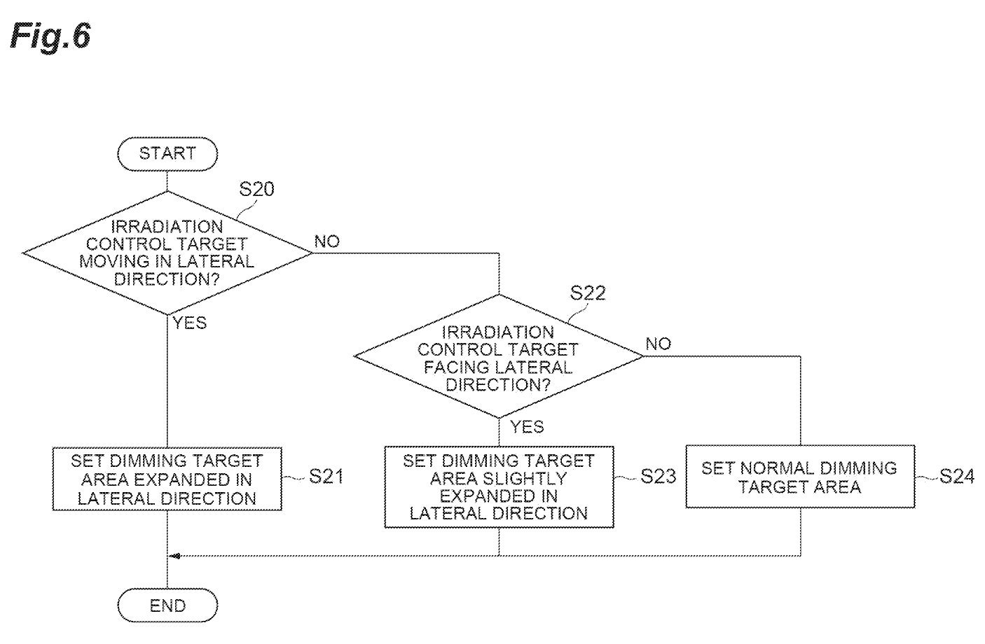

FIG. 6 is a flowchart showing an example of a dimming target area setting process. The dimming target area setting process shown in FIG. 6 is executed, for example, in step S16 or step S18 of FIG. 5.

As shown in FIG. 6, first, in step S20, the ECU 10 determines whether the irradiation control target is moving in the lateral direction. When it is determined that the irradiation control target is moving in the lateral direction, the ECU 10 proceeds to step S21.

In step S21, the ECU 10 sets a dimming target area that is expanded in the lateral direction. Specifically, when the irradiation control target is moving in the lateral direction, the dimming target area is widened in consideration of its movement range, so that appropriate dimming control is always performed without the irradiation control target deviating from the dimming target area. As a result, it is possible to effectively suppress glare to the irradiation control target. Thereafter, the ECU 10 ends the dimming target area setting process.

On the other hand, when it is determined in step S20 that the irradiation control target is not moving in the lateral direction, the ECU 10 proceeds to step S22. In step S22, the ECU 10 determines whether the irradiation control target is facing the lateral direction. Facing the lateral direction means that the face of the pedestrian or the person on the bicycle, who is the irradiation control target, is facing the left-right direction as viewed from the vehicle. When it is determined that the irradiation control target is facing the lateral direction, the ECU 10 proceeds to step S23.

In step S23, the ECU 10 sets a dimming target area that is slightly expanded in the lateral direction. Specifically, when the irradiation control target is facing the lateral direction, in order that its face and upper body do not deviate from the dimming target area, it is set slightly wider than the normal dimming target area. This makes it possible to perform appropriate dimming control and suppress glare to the irradiation control target even when the irradiation control target is facing the lateral direction. The dimming target area set in step S23 can have a shorter width W than the dimming target area set in step S21. Thereafter, the ECU 10 ends the dimming target area setting process.

When it is determined in step S22 that the irradiation control target is not facing the lateral direction, the ECU 10 proceeds to step S24. In step S24, the ECU 10 sets a normal dimming target area. Specifically, when the irradiation control target is not moving in the lateral direction or is not facing the lateral direction, a dimming target area of a normal size is set. The normal size is, for example, the size of the initial setting. The normal dimming target area is a narrower area than the dimming target areas set in step S21 and step S23. Thereafter, the ECU 10 ends the dimming target area setting process.

According to the vehicle lamp control system 100 described above, since the dimming target area is changed according to the moving direction or the orientation of the irradiation control target, the dimming target area can be set appropriately as compared to a case where the moving direction or orientation of the irradiation control target is not considered. This makes it less likely for the irradiation control target to move out of the dimming target area even if the irradiation control target moves, and can effectively suppress the occurrence of glare. In addition, for pedestrians and bicycles, glare can be suppressed by setting the dimming target area to include the head.

Further, in the vehicle lamp control system 100, by setting the lateral width of the dimming target area to be larger when the irradiation control target is moving in a lateral direction as viewed from the vehicle, as compared to when the irradiation control target is not moving in the lateral direction, it is possible to make it less likely for the irradiation control target to move out of the dimming target area even if the irradiation control target moves in the lateral direction, and it is possible to appropriately set the dimming target area based on the situation of the irradiation control target. Similarly, by setting the lateral width of the dimming target area to be larger when the irradiation control target is facing in the lateral direction, as compared to when the irradiation control target is not facing in the lateral direction, it is possible to make it less likely for the irradiation control target to move out of the dimming target area even if the irradiation control target moves in the lateral direction, and it is possible to appropriately set the dimming target area based on the situation of the irradiation control target. This makes it possible to realize more effective dimming control.

Although the embodiments of the present invention have been described above, the present invention is not limited to the above-described embodiments. The present invention can be implemented in various forms to which various modifications and improvements have been made based on the knowledge of those skilled in the art, including the above-described embodiments.

The vehicle lamp control system 100 does not necessarily need to have the collision possibility determination unit 12. The vehicle lamp control system 100 may be of an aspect that executes dimming control or brightening control when an irradiation control target is detected, regardless of the possibility of collision. The vehicle lamp control system 100 may, for example, target an irradiation control target existing within a certain distance from the course of the vehicle for brightening control.

The vehicle lamp control system 100 can individually perform dimming control and brightening control for a plurality of irradiation control targets. The vehicle lamp control system 100 may perform brightening control for an irradiation control target with a high possibility of collision with the vehicle, and perform dimming control for an irradiation control target with a low possibility of collision with the vehicle, among a plurality of irradiation control targets located in the irradiation range of the high-definition headlamp 7.

The vehicle lamp control system 100 may be of an aspect that executes dimming control for the irradiation control target even when the possibility of collision is high. The vehicle lamp control system 100 may, when the possibility of collision is high, execute dimming control with the amount of dimming significantly reduced, as compared to when the possibility of collision is not high. In this case, the vehicle lamp control system 100 may execute both dimming control for a dimming target area including the face and brightening control for a brightening target area not including the face, for an irradiation control target for which it is determined that the possibility of collision is high.

The vehicle lamp control system 100 may be of an aspect that considers the weather conditions around the vehicle for the dimming control and brightening control. The lamp control unit 14 can recognize the weather conditions, for example, by a rain drop sensor or a wiper operating state of the vehicle, or by acquiring weather information from an external server. When it is raining or foggy, glare is less likely to occur on the irradiation control target, while a decrease in the recognition accuracy of the irradiation control target by the front camera 1 is more likely to occur. For this reason, the vehicle lamp control system 100 may be configured not to perform dimming control during bad weather such as rain or fog.

On the other hand, the vehicle lamp control system 100 may lower the threshold value for collision possibility determination and perform brightening control also for an irradiation control target that is slightly away from the vehicle. In addition, the vehicle lamp control system 100 may set the light amount in the brightening control to a larger value during bad weather such as rain or fog, as compared to when it is not bad weather. Although pedestrians and bicycles are exemplified as irradiation control targets, the irradiation control target during brightening control may include animals such as dogs, cats, and deer, and may include objects on the road such as parked vehicles and fallen objects. Even when the irradiation control target is an animal, a brightening target area can be set in a portion where glare does not occur, avoiding the face.

The vehicle lamp control system 100 may change the dimming target area according to the moving speed when the irradiation control target is moving. The vehicle lamp control system 100 may make the size of the dimming target area larger as the moving speed of the irradiation control target is faster, and may change the shape of the dimming target area so that it extends in the moving direction as the moving speed of the irradiation control target is faster.

What is claimed is:

1. A vehicle lamp control system that, when an irradiation control target in front of a vehicle is detected, performs dimming control to suppress glare of the irradiation control target by controlling light irradiation from lamps of the vehicle, the system comprising:
a control target area setting unit that sets a dimming target area for the dimming control for the irradiation control target,
wherein the control target area setting unit changes the dimming target area according to a moving direction of the irradiation control target or a face orientation of the irradiation control target when the irradiation control target is a person.

2. The vehicle lamp control system according to claim 1, wherein the control target area setting unit sets the dimming target area to include a head of the irradiation control target.

3. The vehicle lamp control system according to claim 2, wherein the control target area setting unit sets the dimming target area such that the lateral width of the dimming target area is larger when the irradiation control target is moving in a lateral direction as viewed from the vehicle, as compared to when the irradiation control target is not moving in the lateral direction.

4. The vehicle lamp control system according to claim 2, wherein the control target area setting unit sets the dimming target area such that a lateral width of the dimming target area is larger when a face of the irradiation control target is facing in a lateral direction as viewed from the vehicle, as compared to when the face of the irradiation control target is not facing in the lateral direction.

5. The vehicle lamp control system according to claim 3, wherein the control target area setting unit sets the dimming target area such that a lateral width of the dimming target area is larger when a face of the irradiation control target is facing in a lateral direction as viewed from the vehicle, as compared to when the face of the irradiation control target is not facing in the lateral direction.

6. A control method for a vehicle lamp control system that, when an irradiation control target in front of a vehicle is detected, performs dimming control to suppress glare of the irradiation control target by controlling light irradiation from lamps of the vehicle, the method comprising:
setting a dimming target area for the dimming control for the irradiation control target; and
changing the dimming target area according to a moving direction of the irradiation control target or a face orientation of the irradiation control target when the irradiation control target is a person.

7. A non-transitory computer-readable storage media stored a program that causes a computer of a vehicle to operate to perform dimming control to suppress glare of an irradiation control target by controlling light irradiation from lamps of the vehicle when the irradiation control target in front of the vehicle is detected, the program causing the computer to:
operate as a control target area setting unit that sets a dimming target area for the dimming control for the irradiation control target; and
in the control target area setting unit, change the dimming target area according to a moving direction of the irradiation control target or a face orientation of the irradiation control target when the irradiation control target is a person.
